(19) United States
(12) Patent Application Publication
(10) Pub. No.: US 2006/0034039 A1
(43) Pub. Date: Feb. 16, 2006

(54) Apparatus with display

(76) Inventor: Bas Jan Emile Van Rens, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/530,064

(22) PCT Filed: Sep. 12, 2003
(86) PCT No.: PCT/IB03/04055

§ 371 Date: Mar. 31, 2005

(30) Foreign Application Priority Data
Oct. 4, 2002 (NL) 02079131.5

(51) Int. Cl. G06F 1/16

(52) U.S. Cl. 361/681

(57) ABSTRACT

A display system makes use of removable or detachable display panels (10, 14), which are preferably rollable, such as cartridges which can be discarded after the display stops functioning. The actual display has a two part housing (4,5), one of which contains the removable or detachable display panel. This housing (4) contains electronics like a battery, input devices (buttons, joystick), a radio frequency (RF) antenna and chips and possibly memory and processors. The other housing (5) contains the display panel (14) or substrate (10). If the display panel (14) or substrate (10) tears, which is not unlikely for flexible, thin, displays, only the panel has to be replaced and not the complete device.

The invention relates to an electronic apparatus suitable for displaying information via a display device, the display device having at least one display panel and being provided with driving electronics, the electronic apparatus being provided with means for providing display parameters to the display device.

The invention furthermore relates to a display device for use in such an apparatus and to a housing for such a display panel.

The display device may belong to one of the groups of liquid crystal display devices, electrochromic display devices, electrophoretic display devices, reflective display devices including an interferometric modulator and luminescent display devices. The display devices may be passive or active matrix display devices. Examples of such active matrix display devices are TFT-LCDs or AM-LCDs, (O) LED devices, which are used in laptop computers and in organizers, but also find an increasingly wider application in GSM telephones.

Such matrix displays are generally addressed by means of selection lines which periodically address (a group of) selection lines or rows, e.g. via switches such as TFT (MOS)-transistors, while at the same time data (voltages) are provided via (a group of) data lines or columns. So “display parameters” is meant to comprise these driving signals, but may also comprise other interface signals between the display device (module) and the electronic apparatus. For many applications this should preferably be a standard interface. It may for instance comprise signals like a vertical synchronization pulse, a horizontal synchronization pulse, clock signals etcetera. It may also comprise information with respect to the size and resolution or any other relevant information (color or monochrome) with respect to an application.

In many applications nowadays, like laptop computers and organizers (but of course also in GSM telephones) portable (display) devices are preferred. Portability however goes at the cost of a higher chance of breaking the display since most displays are rather fragile systems. The costs of exchanging a broken display from a portable device however are so prohibitively high that usually the device is replaced completely. Since 99% of the functionality still remains available, this is a waste of resources. The reasons for these high costs are twofold. First, the display is molded into the device to give it added strength. Consequently, removing the display entails breaking the device. Second, once the display is removed a new display has to be aligned in the device and considering the large amount of connections (tens of thousands to more than a million) this is a complex task.

In other applications, especially mobile telephones, a need is felt to have a display area, which is larger than the area available within the device. This need has been solved by introducing rollable displays. When moving to rollable displays the above mentioned protective measures have to be omitted while the substrates generally become much thinner and therefore more vulnerable.

It is one of the objects of the invention to overcome at least partly the above mentioned problem. To this end in a first electronic apparatus according to the invention the display panel is provided outside the electronic apparatus and is movable between a first position and a second position in which the display device has a first housing, the first housing comprising the display panel in one of the first and second positions and a second housing comprising driving electronics for the display panel.

In a preferred embodiment the display panel is movable between a first position in which the display panel substantially is not visible and a second position in which at least part of the display panel is visible. Intermediate distinct positions may be made available too.

By “substantially is not visible” it is meant that the greater part of actual display panel is not visible to the human eye, be it because it is within a housing or because the display panel is in a folded or rolled up position. The wording “part of the display panel” need not refer to a viewable part of the display panel. The display panel may be realize as both foldable and rollable, in which case e.g. a substrate carrying separate display panels is rolled out in a folded position, after which it is unfolded.

The invention is based on the insight that rather than making the displays more robust one can make use of displays in housings (for instance cartridges) which displays (and housings) can be discarded after the display stops functioning. This is the more attractive when flexible displays (e.g. including integrated row and column drivers) are used and cheap “plastic electronics” become available. By providing the display panel in only one of the two housings the amount of driving electronics within such a display device housing is minimal, making the use of disposable display panels more attractive.

In a preferred embodiment the first housing comprises fixing means for fixing the first housing in an enclosure. Such fixing means for fixing the first housing in the enclosure may be selected from the group of spindle mechanisms, clicking mechanisms, magnetic fixing and gluing. This opens the way to providing disposable display panels, which may be (temporarily) stored in such enclosures.

The display device and the electronic apparatus may be mechanically interconnected or mechanically interconnectable, dependant on the kind of use. Also wireless communication is possible. This enables the use of such display devices in more than one apparatus and even opens the possibility of “loading” such display devices with data, similar to loading badges, credit cards or similar devices.

As mentioned above at least part of the display panel may be flexible, which makes the use of rollable or foldable displays possible.

In this case a preferred embodiment has the housing of the display panel at a side different from the side of the apparatus provided with the (mechanical )interconnection.

The use of one display panel in several apparatuses need not be excluded to the applications as mentioned, but having cheap display panels also introduces the possibility of interchanging display panels per se, either by replacing a display panel in an apparatus or by using the same display panels in several apparatuses. To this end one preferred embodiment of a display according to the invention the display device or the electronic apparatus has a clamping mechanism to interconnect conducting patterns of the driving electronics in the display device or the electronic apparatus to conducting patterns of the display panel.

These and other aspects of the invention are apparent from and will be elucidated with reference to the embodiments described hereinafter.

In the drawings:

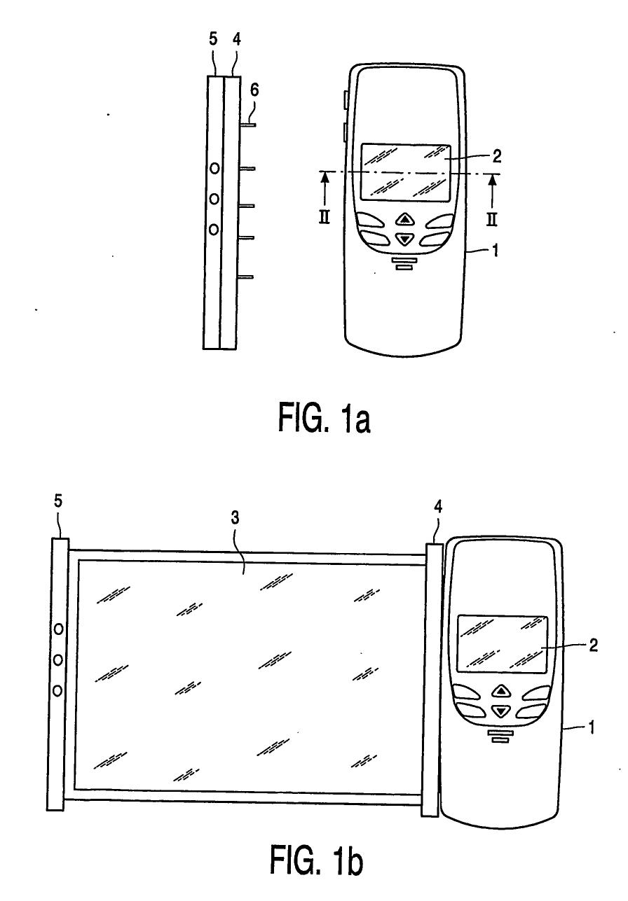

FIG. 1 shows the use of a rollable display device in mobile applications

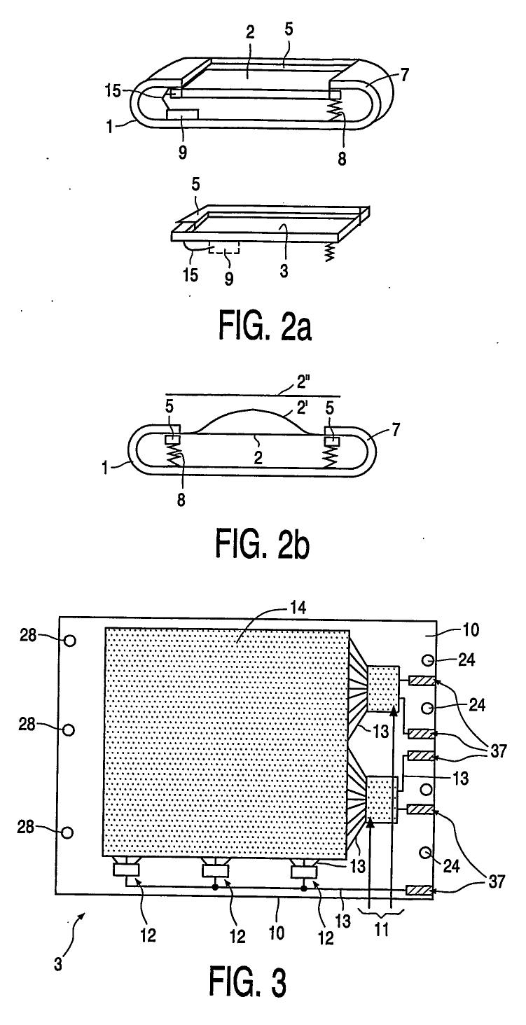

FIG. 2 shows embodiments of the apparatus of FIG. 1 as seen in cross-section along line II-II, having a replaceable display device or display panel according to the invention,

FIG. 3 is an electrical equivalent of a part of the rollable display device,

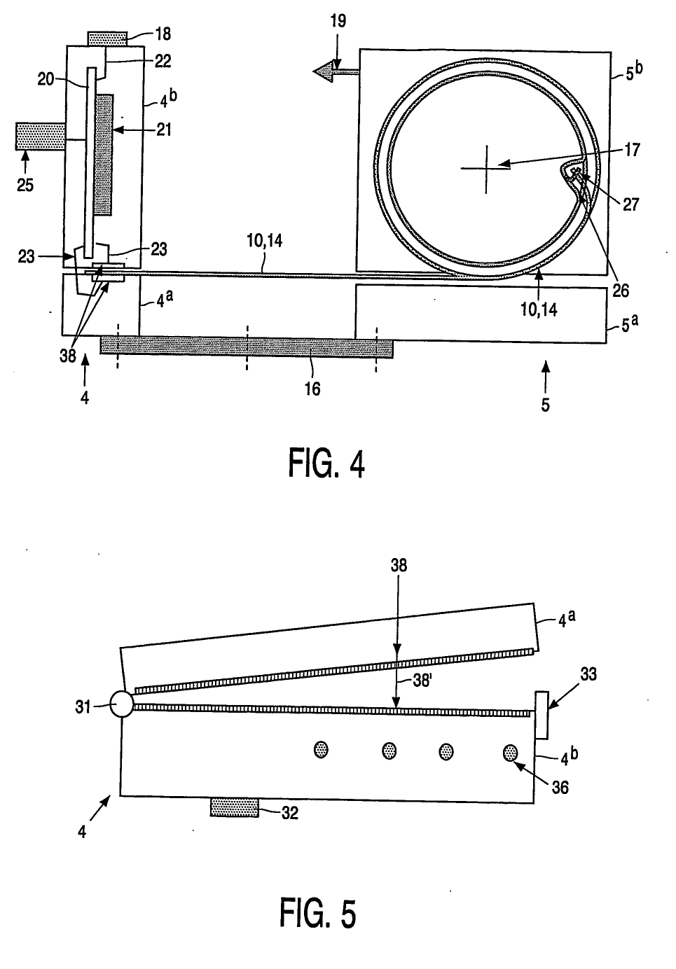

FIG. 4 shows a housing of the rollable display device according to the invention while

FIG. 5 shows a separate part of the housing of the device according to the invention and

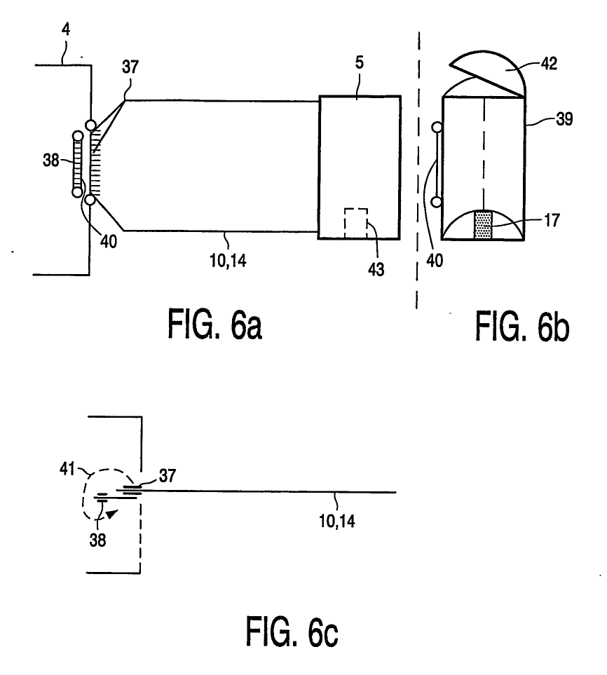

FIG. 6 shows a further embodiment according to the invention

The Figures are diagrammatic and not drawn to scale. Corresponding elements are generally denoted by the same reference numerals.

FIG. 1 shows the use of such a display panel in a first kind of application. In FIG. 1^{a} one typical example is given viz. the use of displays in a mobile telephone 1. A typical display device (panel) 2 of the mobile telephone has dimensions of e.g. 2 cm×3 cm, whereas the mobile telephone itself has dimensions of e.g. 4 cm×10 cm. A further rollable display 3 is provided inside a housing 4, 5 and may be interconnected to the mobile telephone 1 via interconnecting pins 6. The housing in this example comprises two different parts 4, 5, the display panel 3 in this example being situated in part 5 in its rolled form, while part 4 comprises further driving electronics and e.g. batteries. FIG. 1^{b} shows the unrolled display 3, which has dimensions of e.g. 10 cm ×15 cm.

FIG. 2 shows the use of a replaceable panel in another kind of application. Now a display panel 3 is bendable and has a housing 5 e.g. a frame around the display panel 3. In this case an edge of the display panel 3 is provided with interconnecting means 15, which provide driving signals to the display panel. These driving signals are e.g. generated in a driving circuit (IC) 9, which also may generate and receive functional parameters as will be described below with reference to FIG. 4. At the areas of the frame 5 springs 8 or other clamping means push the edge of the display against the housing 7. Since the display panel 3 is bendable it can easily be inserted as a replaceable display panel within the apparatus (mobile telephone 1).

In FIG. 2^{a} the display device as a whole is detachable, including the frame 5 and the springs 8. If necessary (part) of the driving circuit (ICs) 9 can be realized at the backside of the display panel, especially when emitting display principles or reflecting display principles are used (as shown by broken lines in the lower part of FIG. 2^{a}).

In FIG. 2^{b} the frame 5 and the springs 8 remain within the housing 7 while the display panel 2 can be bended to such an extend that its ends are free (denoted as 2′ in FIG. 2^{b}) and pulled out. If the display panel 2 has to be replaced a new display panel (denoted as 2″ in FIG. 2^{b}) is provided and bended (comparable to 2′ in FIG. 2^{b}) after which the display panel 2 is clamped within the housing 7.

One of the advantages of having a replaceable display device or display panel is that it can be used on several apparatuses, provided some standardization has been agreed upon (display size, and if necessary handshake protocols).

FIG. 3 is an electric equivalent circuit diagram of a part of a possible display panel 3 according to the invention. It comprises in one possible embodiment (one mode of driving, called the “passive mode”) a matrix of pixels defined by the areas of crossings of row or selection electrodes and column or data electrodes. The row electrodes are consecutively selected by means of row drivers 11 (via interconnection patterns 13), while the column electrodes are provided with data via data registers 12. To this end, further interconnections 13 between the row drivers and conductive pads 37 and between the data registers and conductive pads 37 are provided on the (flexible) display substrate 10. Reference numeral 14 represents the actual display area In the embodiment of FIG. 2 these row drivers and data registers are provided in the electronics of the housing of the apparatus. Mixed solutions are of course possible e.g. realizing these electronics (partly) in the housing 4 while the display panel has some simple electronics only.

In another possible embodiment (another mode of driving, called the “active mode”) signals from the row drivers select the picture electrodes via thin-film transistors (TFTs) whose gate electrodes are electrically connected to row electrodes while the source electrodes are electrically connected to column electrodes.

FIG. 4 schematically shows how part of the substrate 10 is fixed within a first housing part 5. The housing part 5 in this example comprises a (spring-loaded) rolling device 17 for rolling up the (flexible) display substrate 10.

Support hinges 16 may reinforce the mechanical stability of the total construction. Furthermore in this example a locking mechanism 19 is schematically shown to lock the housing parts 4, 5 together when the display is in a rolled position. To release the (flexible) display substrate 10 again the housing part 4 has a push button 18.

The housing part 4 in this example comprises a printed circuit board 20. On the printed circuit board driver chips 21 and electrical interconnections 22 to interactive push buttons 18 (or other interaction devices) are provided together with electrical interconnections 22 which (via conductors 23) contact the array of contact pads 38, which may make contact to contact pads 37. The contact pads can be located on both sides of the display foil (as shown here) or only on one side. Also, it should be noted that this housing part 4 can contain further chips, batteries and in particular antennas to enable e.g. an RF link between the apparatus 1 and the display device 2, rather than through electrical interconnections 25 or between the display device 2 and the display panel 3, rather than through the connecting parts 6 drawn in FIG. 4. Especially the driver chips 21 or further circuitry on printed circuit board 20 may be used for the implementation of a (standard) protocol concerning the exchange of information, e.g. how to use different kinds of display panels (with different number of lines, number of columns etcetera) in different kinds of apparatuses.

In this example the housing 4 comprises two parts 4^{a}, 4^{b} between which the display panel 14 (the flexible substrate 10) can be clamped for contacting the connecting parts 6 to conductors 23 (in this example double sided contacting is shown). In another embodiment the housing 4 may comprise only a slit to introduce display panel into a receiving section.

It should be noted that the width of the display panel not is restricted to the dimensions of such a slit. The dimension of the housing 5 determines the maximum width of the substrate 10 in the embodiment shown. However as mentioned in the introduction, the substrate 10 may be foldable in a direction transverse to the rolling direction, in which case wider display panels can be provided in said housing.

The contact pads will be aligned with the display's contact areas through alignment pegs or recessions (holes 24) in the substrate 10 or any type of optical or mechanical feedback mechanism for proper alignment. Since the display will typically contain only a few contact pads these contacts can be large and therefore a rough alignment is sufficient.

The first housing part 5 contains the rolling device 17 for rolling up the (flexible) display substrate 10. This housing part 5 in this example also comprises two parts 5^{a}, 5^{b}. The mechanism is designed in such a way that it can only open when the display panel 14 (the flexible substrate 10) is fully rolled out. Then, separating of the two parts 5^{a}, 5^{b} will lock the spring-loaded roll-up mechanism so that it cannot roll back while the two parts are separated. In this fully rolled-out position the recession 26 (in the rolling device 17 in FIG. 4) for loading the display panel 14 is for example pointing downwards. The display panel 14 can then be unhooked from the hooks 27 (in the recession 26 in FIG. 4) that grab (and hold the display during normal operation as a result of the spring the rolls up the display) by moving it in the roll-up direction. The roll-up mechanism is locked in order to achieve this unhooking and a new display (foil) can then be applied over the hooks 27 (which will also serve as an alignment means in combination with holes 28 in the display, see FIG. 3). Upon closing of the two parts the spring is released and the new display is rolled up again.

Both housings 4,5 can be opened in this example as is shown in FIG. 5 for the housing 4 via a hinge 31. A locking mechanism 33 is schematically shown to lock the housing parts together when the display panel 10, 14 has been introduced into the housing 4. To release the (flexible) display panel 14 (substrate 10) again the housing part 4 has a push button 32. The connecting pads 38 receive interconnection patterns 23 of the display panel (in this example double sided contacting is shown). In the housing 5 these connecting pads are deleted.

As mentioned above also wireless communication between the housings 4,5 and between the housings and the apparatus is possible. So a universal housing 4 is obtained which can drive many different kind of display panels. In the same way different kinds of communication between the housing 4 and the apparatus 1 are possible. The housing 4 on the other hand may be incorporated in the apparatus 1.

The design opens the way to both disposable display panels, which makes the use of disposable displays the more attractive, since now only the most vulnerable part, viz. the display panel has to be replaced in kind of damage or failure. On the other hand using a separate housing or panel opens the way to use of disposable displays, which can be plugged in at arbitrary places. Many applications can be thought of, for instance:

plugging a disposable display into the wall of a (banking) office to see if waiting will take long (if necessary the display substrate may be provided with identification electronics).

using the cartridge as a personalized display to plug it in special places for observing purposes (ranging from Kindergarten to stock inventory).

an apparatus for giving lectures for (smaller) audiences in which the lecturer sees a small picture on the apparatus display while the audience at the opposite side of the rolled out display sees an enlarged picture, or even a moving picture.

displaying monochrome (black/white) information on the rolled out part while simultaneously displaying (other) functional (color) displays on the apparatus display a pocket display for general-purpose applications.

The use of a separate housing part 4, which in itself needs not to be disposable makes it attractive to integrate more complex functions in the housing part 4 for instance a pointing device and /or a lens together with means for storing digitized picture (e.g. a charged coupled device, together with further processing means for photograhical purposes). In that case the combination of housing parts 4 can be used for camera purposes, while (afterwards) processing can be done on a further apparatus 1.

One of such applications is shown in FIG. 6, in which the housing 5 is comparable to a cartridge as used in photography, which can be stored in a container or enclosure 39 having a lid 42 and a spindle 17 (FIG. 6^{a,b}), comparable to a photographic film container. The spindle 17 serves to roll up the substrate(display panel) 10, 14 into the housing 5 (cartridge) via an interlocking mechanism 43. Other interlocking mechanisms like clicking mechanisms, magnetic fixing and gluing may be used alternatively. The rollable substrate (display panel) 10, 14 at its extendable end has a mechanical connection 40. In FIG. 6^{c} this mechanical connection 40 is fixed in the housing 4 to a further mechanical connection (not shown) via a fixing mechanism 41 to interconnect contact pads 37, 38.

These applications will be most attractive of course if a standard way of (mechanically) interconnecting the display to the apparatus is agreed upon and if a (standard) protocol concerning the exchange of information exists, e.g. how to use different kinds of display panels (with different number of lines, number of columns etcetera) in different kinds of apparatuses.

The protective scope of the invention is not limited to the embodiments described, while the invention is also applicable to other display devices, for example, (0) LED displays, and other housing devices.

On the other hand the electronic apparatus 1 comprising the display device (panel) may be suited for different applications (e.g. both a telephone application and a calculator application) which each have different display panels (with different number of lines, number of columns etcetera). The display panels may even be realized in different technologies, e. g. (O) LED-technology for display 2 and LCD technology for display 14.

In many of the possible applications an apparatus display 2 and the rolled out display area need not be visible from one single side. On the other hand the rollable display panel may be viewable from two opposite sides.

Also the interconnection between the apparatus and (part of) the display need not be of an electromechanical kind, such as shown. Electromagnetic coupling (infrared radiation) may be used to provide data to the display device or to the display panel.

The row drivers 11 and the data registers 12 can be implemented in the housing 4 too, when displays panels are used having all connections to the row and column electrodes on one side.

Several mechanisms known in the art for attaching a rollable substrate (film) to both types of housings or for storing the housing 5 in the enclosure 39 may be used.

The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

1. An electronic apparatus suitable for displaying information via a display device, the display device having at least one display panel and being provided with driving electronics, the electronic apparatus being provided with means for providing display parameters to the display device, the display device being provided outside the electronic apparatus and being movable between a first position and a second position in which the display device has a first housing, the first housing comprising the display panel in one of the first and second positions and a second housing comprising driving electronics for the display panel.

2. An electronic apparatus according to claim 1, the first housing comprising fixing means for fixing the first housing in an enclosure.

3. An electronic apparatus according to claim 2, the fixing means for fixing the first housing in the enclosure being selected from the group of spindle mechanisms, clicking mechanisms, magnetic fixing and gluing.

4. An electronic apparatus according to claim 2 having closing means for the enclosure.

5. An electronic apparatus according to claim 1, the display panel being movable between a first position in which the display panel substantially is not visible and a second position in which at least part of the display panel is visible.

6. An electronic apparatus according to claim 5, the display panel being movable to at last one further position in which the display panel is partly visible.

7. An electronic apparatus according to claim 1, the second housing and the electronic apparatus being mechanically interconnected.

8. An electronic apparatus according to claim 1, the second housing and the electronic apparatus being mechanically interconnectable.

9. An electronic apparatus according to claim 1, the driving electronics in the second housing and electronic circuitry in the electronic apparatus being interconnectable by electromagnetic coupling.

10. An electronic apparatus according to claim 1, at least part of the display panel being flexible the display panel being rollable or foldable.

11. An electronic apparatus according to claim 1, the display panel in at least one of the first and second positions being fixed by a spring mounting or a spindle mechanism in the first housing.

12. An electronic apparatus according to claim 1, the driving electronics in the second housing and the display panel being electrically interconnectable by mechanical coupling.

13. An electronic apparatus according to claim 12 having a clamping mechanism to interconnect conducting patterns of the driving electronics in the second housing to conducting patterns of the display panel.

14. An electronic apparatus according to claim 1, in which the first housing comprises means for introducing and fixing the display panel.

15. An electronic apparatus according to claim 1 having a further display device.

16. An electronic apparatus according to claim 1, the electronic apparatus comprising the second housing

17. An electronic apparatus according to claim 1, the electronic apparatus comprising a controller for selecting at least one application for the display device and further comprising memory means for storing at least display parameters related to said application and means for providing said display parameters to an interface between the electronic apparatus and the display device.

18. An electronic apparatus suitable for displaying information via a display device, the display device having a display panel provided with driving electronics, the electronic apparatus being provided with means for providing display parameters to the display device, the display device having at least one movable housing, the housing comprising the display panel and the electronic apparatus comprising driving electronics for the display device.

19. An electronic apparatus suitable for displaying information via a display device, the display device having a display panel provided with driving electronics, the electronic apparatus being provided with means for providing display parameters to the display device, the display device having a clamping mechanism to interconnect conducting patterns of the driving electronics in the apparatus to conducting patterns of the display panel.

20. A display device having a display panel, the display panel being movable between a first position and a second position in which at least part of the a display panel is visible, in which the display device has a first housing, the first housing comprising the display panel in one of the first and second positions and a second housing comprising driving electronics for the display panel.

21. A display device according to claim 20, the first housing comprising fixing means for fixing the first housing in an enclosure.

22. A display device according to claim 21, the fixing means for fixing the first housing in the enclosure being selected from the group of spindle mechanisms, clicking mechanisms, magnetic fixing and gluing.

23. A display device according to claim 21 having closing means for the enclosure.

24. A display device according to claim 20, the display panel being movable between a first position in which the display panel substantially is not visible and a second position in which at least part of the display panel is visible.

25. A display device according to claim 20, at least part of the display panel being flexible the display panel being rollable or foldable.

26. A display device according to claim 20, the display panel in at least one of the first and second positions being fixed by a spring mounting to the first housing.

27. A display device according to claim 20, the driving electronics in the second housing and the display panel being electrically interconnectable by mechanical coupling.

28. A display device according to claim 26, having a clamping mechanism to interconnect conducting patterns of the driving electronics in the second housing to conducting patterns of the display panel.

29. A display device according to claim 20, in which the first housing comprises means for introducing and fixing the display panel.

30. A display device according to claim 20 having driving electronics and, having a clamping mechanism to interconnect conducting patterns of the driving electronics to conducting patterns in a movable housing.

31. A housing for a display panel, the display panel being movable within the housing between a first position and a second position in which at least part of the a display panel is visible, the housing comprising fixing means for fixing the housing in an enclosure.

32. A housing according to claim 31, the fixing means for fixing the first housing in the enclosure being selected from the group of spindle mechanisms, clicking mechanisms, magnetic fixing and gluing.

33. A housing according to claim 31, at least part of the display panel being flexible the display panel being rollable or foldable.

34. A housing according to claim 31 in which the housing comprises means for introducing and fixing the display panel.
